(19) United States
(12) Patent Application Publication
(10) Pub. No.: US 2017/0117657 A1
(43) Pub. Date: Apr. 27, 2017

(54) CONNECTOR

(71) Applicant: Sumitomo Wiring Systems, Ltd., Yokkaichi (JP)

(72) Inventor: Hiroshi Inoue, Yokkaichi (JP)

(21) Appl. No.: 15/283,907

(22) Filed: Oct. 3, 2016

(30) Foreign Application Priority Data
Oct. 21, 2015 (JP) 2015-207186

(51) Int. Cl. H01R 13/436; H01R 9/24

(52) U.S. Cl. CPC H01R 13/4364; H01R 9/2416

(57) ABSTRACT

A connector has a front retainer (20) with a detecting portion (32) and a detecting surface (24) formed on a rear end part of the detecting portion (32). The detecting surface is inclined with respect to a virtual orthogonal plane (S) orthogonal to a mounting direction of the front retainer (20) and butts against a locking lance (12) located in a deflection space (13) when a terminal fitting (16) is in an incompletely inserted state. A first pressure receiving surface (23) and a second pressure receiving surface (26) formed on the rear end part of the detecting portion (22) are set to be at a smaller angle to the virtual orthogonal plane (S) than an angle of the detecting surface (24) to the virtual orthogonal plane (S).

### BACKGROUND

1. Field of the Invention

The present invention relates to a connector.

2. Related Art

Japanese Unexamined Patent Publication No. 2013-118087 discloses a connector with a front retainer to be mounted to a housing from front. A terminal accommodating chamber and a locking lance are formed in the housing. In the process of inserting a terminal fitting into the terminal accommodating chamber from behind the housing, the locking lance is resiliently deformed to enter a deflection space due to interference with the terminal fitting. With the terminal fitting properly inserted, the locking lance is resiliently restored to retain and lock the terminal fitting.

The front retainer is formed with a detecting portion. The detecting portion projects in parallel to a mounting direction of the front retainer to the housing. When the front retainer is mounted with the terminal fitting properly inserted, the detecting portion enters the deflection space to restrict resilient deformation of the locking lance in a direction to be separated from the terminal fitting. Further, if an attempt is made to mount the front retainer with the terminal fitting incompletely inserted, a detecting surface formed on a projecting end part of the detecting portion butts against a front end part of the locking lance. Thus, the front retainer cannot be correctly mounted. Therefore, an inserted state of the terminal fitting can be detected based on whether or not the front retainer can be correctly mounted.

Further, in this connector, if the detecting portion pushes away the locking lance toward the terminal fitting and enters the deflection space when the detecting portion butts against the locking lance with the terminal fitting incompletely inserted, an erroneous detection is made. Accordingly, the detecting surface of the detecting portion is inclined with respect to a surface at a right angle to the mounting direction of the front retainer to prevent an erroneous detection.

In the process of molding the front retainer by a mold, the detecting portion may be improperly deformed if the detecting surface is inclined as described above when the front retainer is pushed out of the mold by an ejector pin pushing the detecting surface of the detecting portion.

The present invention was completed based on the above situation and aims to prevent improper deformation of a detecting portion of a front retainer.

### SUMMARY

The present invention is directed to a connector with a housing formed with a terminal accommodating chamber, a locking lance cantilevered forward and configured to retain a terminal fitting by locking the terminal fitting properly inserted into the terminal accommodating chamber, a deflection space configured to allow the locking lance to be resiliently displaced due to interference with the terminal fitting in an incompletely inserted state, a front retainer to be mounted to the housing from front, a detecting portion formed on the front retainer and configured to restrict the separation of the locking lance from the terminal fitting by entering the deflection space with the terminal fitting properly inserted, a detecting surface formed on a rear end part of the detecting portion, inclined with respect to a virtual orthogonal plane orthogonal to a mounting direction of the front retainer and configured to butt against the locking lance located in the deflection space when the terminal fitting is in the incompletely inserted state, and a pressure receiving surface formed on the rear end part of the detecting portion and set to be at a smaller angle to the virtual orthogonal plane than an angle of the detecting surface to the virtual orthogonal plane.

In releasing the front retainer from a mold in the process of forming the front retainer using the mold, improper deformation of the detecting portion can be prevented if an ejector pin is designed to press the pressure receiving surface.

### BRIEF DESCRIPTION OF THE DRAWINGS

FIG. 1 is a section showing a state where a terminal fitting is properly inserted in a connector of one embodiment.

FIG. 2 is a section showing a state where the terminal fitting is incompletely inserted.

FIG. 3 is a rear view of a front retainer.

FIG. 4 is a section of the front retainer.

FIG. 5 is a partial enlarged section showing the state where the terminal fitting is incompletely inserted.

FIG. 6 is a partial enlarged section showing a state where an ejector pin is pressing a detecting portion.

### DETAILED DESCRIPTION

In the connector of the present invention, two pressure receiving surfaces may be arranged at two positions across the detecting surface in a resilient displacement direction of the locking lance. According to this configuration, pressing positions of the detecting portion by the ejector pin are dispersed at two positions, wherefore improper deformation of the detecting portion can be reliably prevented.

In the connector of the present invention, a restricting portion arranged between the pressure receiving surface and the detecting surface and stepped such that the pressure receiving surface is retracted from the detecting surface may be formed on the rear end part of the detecting portion. According to this configuration, the ejector pin pressing the pressure receiving surface can be prevented from being displaced toward the detecting surface.

In the connector of the present invention, a plurality of the locking lances may be juxtaposed, and the detecting portion may be in the form of a plate to correspond to the plurality of locking lances. According to this configuration, improper deformation of the detecting portion can be more reliably prevented.

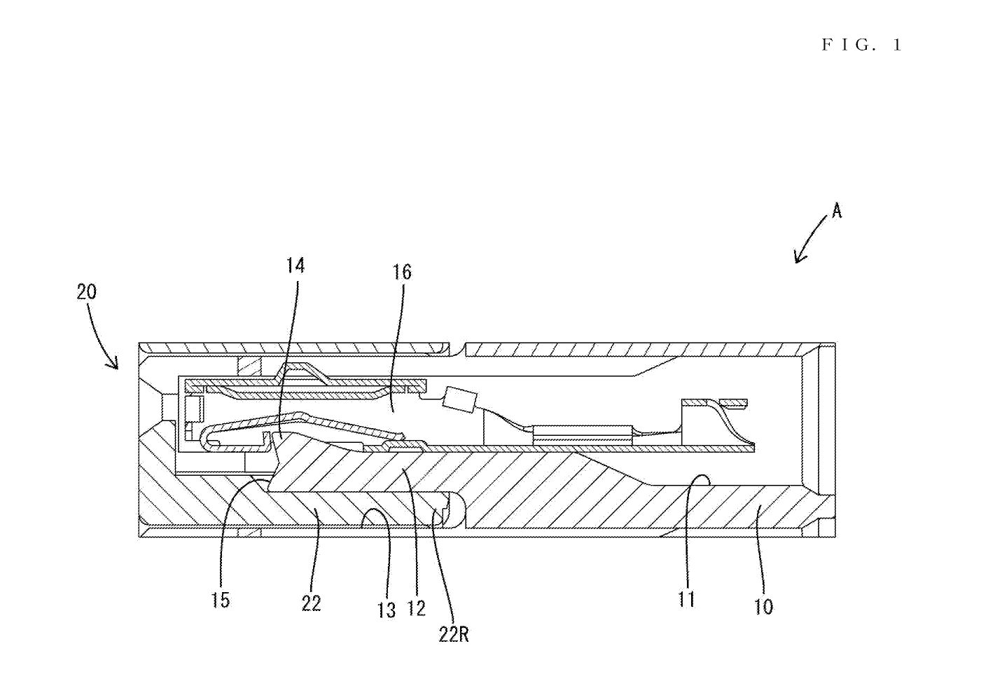

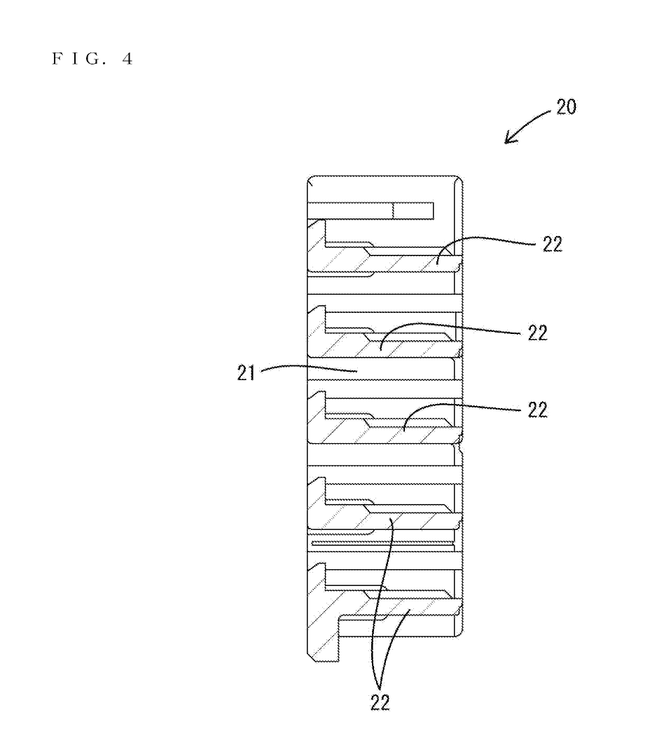

Hereinafter, one specific embodiment of the present invention is described with reference to FIGS. 1 to 6. A connector A of this embodiment includes a housing 10 made of synthetic resin, a plurality of terminal fittings 16 and one front retainer 20 made of synthetic resin.

A plurality of terminal accommodating chambers 11 are formed in the housing 10. The plurality of terminal accommodating chambers 11 are arranged in a plurality of stages separated in a vertical direction, and a plurality of terminal accommodating chambers 11 are juxtaposed in a lateral direction in each stage. A rear end part of the terminal accommodating chamber 11 is open on the rear end surface of the housing 10. The terminal fitting 16 is inserted into each terminal accommodating chamber 11 from behind the housing 10.

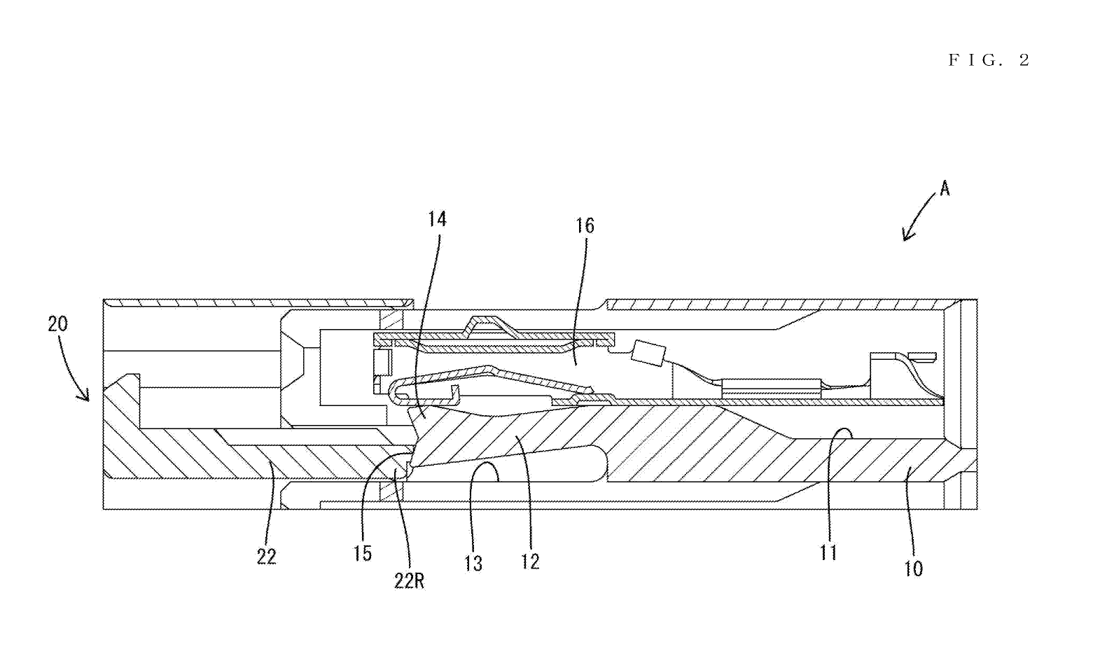

Locking lances 12 cantilevered forward (leftward in FIGS. 1 and 2) along lower walls of the respective terminal accommodating chambers 11 are formed in the housing 10. Likewise, deflection spaces 13 arranged at sides opposite to the terminal accommodating chambers 11 across the locking lances 12 are formed in the housing 10. The front end of the deflection space 13 is open on the front end surface of the housing 10. The locking lance 12 is normally held in a locking posture shown in FIG. 1. Further, when a downward external force acts on the locking lance 12, the locking lance 12 can be resiliently displaced downwardly (in a direction away from the terminal accommodating chamber 11) to enter the deflection space 13 with a rear end part (base end part) thereof as a supporting point.

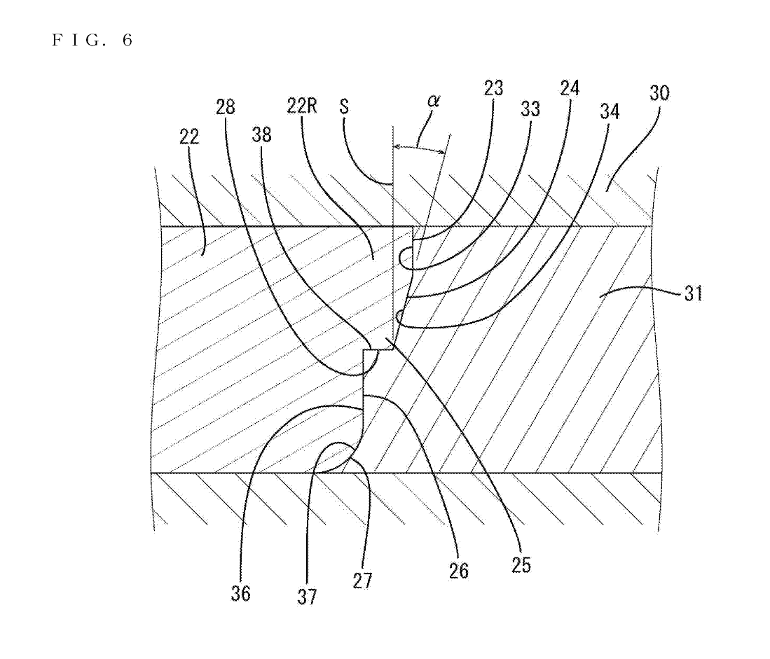

A locking projection 14 projecting upwardly (toward the terminal accommodating chamber 11) is formed on a front end part (extending end part) of the locking lance 12. A receiving surface 15 is formed in an area of the front end surface (projecting end surface) of the locking lance 12 below the locking projection 14 (distant from the terminal accommodating chamber 11). The receiving surface 15 is inclined with respect to a virtual orthogonal plane S (see FIG. 6) orthogonal to a front-back direction (mounting direction of the front retainer 20 to the housing 10) and obliquely facing toward an upper-front side.

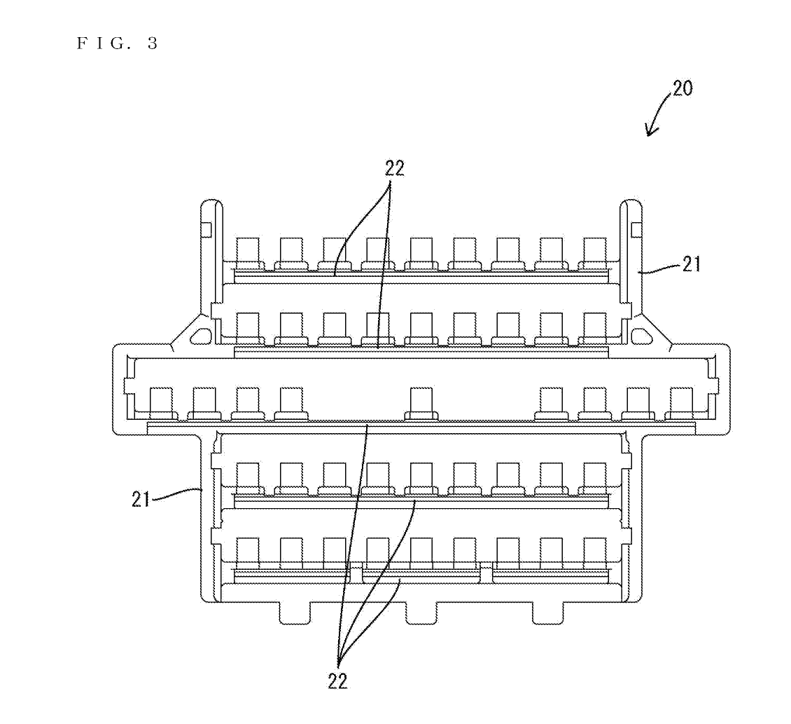

As shown in FIG. 3, the front retainer 20 is a single component with a pair of left and right side frame portions 21 and a plurality of detecting portions 22 arranged to extend between the both side frame portions 21. The front retainer 20 is mounted to the housing 10 from the front side of the housing 10. The mounting direction of the front retainer 20 is the front-back direction, i.e. a direction intersecting substantially at a right angle with a resilient displacement direction of the locking lances 12. The detecting portion 22 is in the form of a plate long and narrow in the lateral direction (direction parallel to a juxtaposition direction of the terminal accommodating chambers 11). In mounting the front retainer 20 to the housing 10, the front retainer 20 is brought closer to the housing 10 with rear end parts 22R of the detecting portions 22 facing forward.

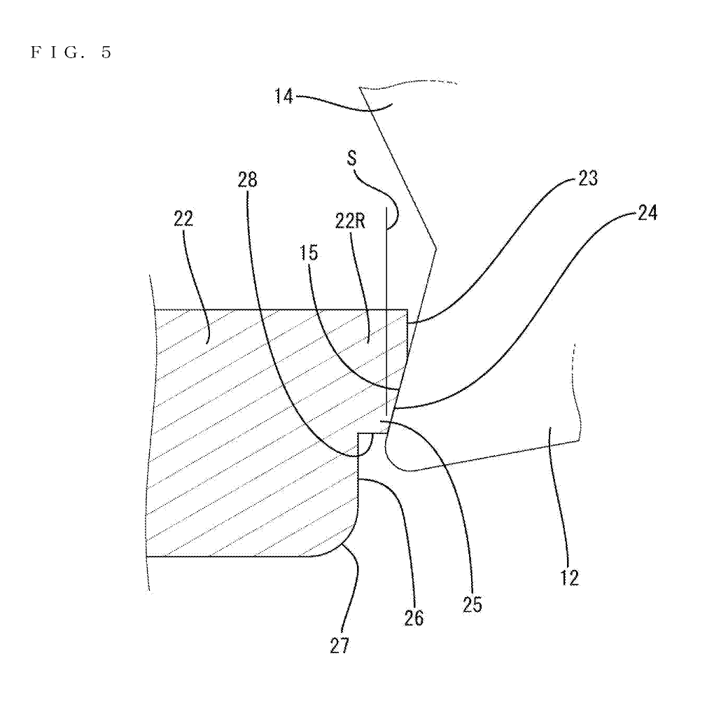

As shown in FIGS. 5 and 6, the rear end part 22R (rear end surface) of the detecting portion 22 is formed with a first pressure receiving surface 23 (pressure receiving surface as claimed), a detecting surface 24, a restricting portion 25, a second pressure receiving surface 26 (pressure receiving surface as claimed) and an arcuate convex surface 27. Any of these surfaces 23 to 27 is continuous substantially over the entire width of the detecting portion 22 and formed to be long and narrow in the lateral direction to correspond to the plurality of terminal accommodating chambers 11 and the plurality of locking lances 12 juxtaposed in the lateral direction.

In the vertical direction (plate thickness direction of the detecting portion 22), the first pressure receiving surface 23 is arranged on an uppermost end edge part of the rear end surface of the detecting portion 22. The detecting surface 24 is arranged below and adjacent to the first pressure receiving surface 23. Thus, a lower end edge part of the first pressure receiving surface 23 and an upper end edge part of the detecting surface 24 are connected at a predetermined angle. The restricting portion 25 is stepped when viewed laterally. A lower end edge part of the detecting surface 24 constitutes an upper end part of the restricting portion 25. The restricting portion 25 has a restricting surface 28 facing downward. A rear end edge part of the restricting surface 28 and the lower end edge part of the detecting surface 24 are connected at a predetermined angle.

The second pressure receiving surface 26 is arranged on a lower end edge part of the rear end surface of the detecting portion 22. A front end edge part of the restricting surface 28 and an upper end edge part of the second pressure receiving surface 26 are connected at a predetermined angle. Since an area from a lower end part of the detecting surface 24 to an upper end part of the second pressure receiving surface 26 serves as the stepped restricting portion 25, the second pressure receiving surface 26 is retracted forward with respect to the detecting surface 24. That is, an area of the rear end surface of the detecting portion 22 where the restricting surface 28 and the second pressure receiving surface 26 are formed is recessed. The arcuate convex surface 27 is arranged on a lowermost end edge part of the rear end surface of the detecting portion 22. The arcuate convex surface 27 is connected tangentially (smoothly) to the second pressure receiving surface 26 and the lower surface of the detecting portion 22.

As a means for specifying the orientation of each of the above surfaces 23 to 28, the virtual orthogonal plane S orthogonal to the mounting direction of the front retainer 20 to the housing 10 (hereinafter, merely referred to as the “mounting direction”) is defined as shown in FIG. 6. An angle of the first pressure receiving surface 23 to the virtual orthogonal plane S is 0°. An angle of the second pressure receiving surface 26 to the virtual orthogonal plane S is also 0°. That is, the first and second pressure receiving surfaces 23, 26 are parallel to the virtual orthogonal plane S and at a right angle to the mounting direction of the front retainer 20.

An angle α of the detecting surface 24 to the virtual orthogonal plane S is, for example, 15°. That is, the detecting surface 24 is inclined at an angle close to a right angle with respect to the mounting direction of the front retainer 20 and obliquely facing toward a lower-rear side. This angle α of the detecting surface 24 to the virtual orthogonal plane S is larger than the angles (0°) of the first and second pressure receiving surfaces 23, 26 to the virtual orthogonal plane S. Further, the restricting surface 28 is substantially parallel to the mounting direction of the front retainer 20, i.e. substantially at a right angle to the virtual orthogonal plane S.

Next, an assembling procedure of the connector A is described. The terminal fitting 16 is inserted into the terminal accommodating chamber 11 from behind the housing 10. In the inserting process, the lower surface of the terminal fitting 16 interferes with the locking projection 14 of the locking lance 12, wherefore the locking lance 12 is resiliently displaced to enter the deflection space 13. A state where the locking lance 12 is resiliently displaced into the deflection space 13 without the terminal fitting 16 reaching a proper insertion position is defined as an incompletely inserted state. When the terminal fitting 16 reaches the proper insertion position, the locking lance 12 is resiliently restored toward the terminal accommodating chamber 11 and the locking projection 14 locks the terminal fitting 16. By this locking function, the terminal fitting 16 is retained and held. A state where the terminal fitting 16 reaches the proper insertion position and is retained by the locking lance 12 is defined as a properly inserted state.

After the inserting operation of all the terminal fittings 16 is completed, the front retainer 20 is mounted to the housing 10 from the front side of the housing 10. In the process of mounting the front retainer 20, the detecting portions 22 enter the deflection spaces 13. At this time, if the terminal fittings 16 are properly inserted, the detecting portions 22 enter the deflection spaces 13 without interfering with the locking lances 12 and, as shown in FIG. 1, the front retainer 20 is properly mounted. Since the detecting portions 22 having entered the deflection spaces 13 slip under the locking lances 12, resilient displacements of the locking lances 12 in a direction to be separated from the terminal fittings 16 are restricted.

In contrast, if the terminal fitting 16 is incompletely inserted in any one of the terminal accommodating chambers 11, the locking lance 12 is located in the deflection space 13 as shown in FIG. 2, wherefore the rear end part 22R of the detecting portion 22 butts against the locking lance 12 from front. At this time, the detecting surface 24 of the detecting portion 22 butts against the receiving surface 15 of the locking lance 12 substantially in a surface-contact state. By this butting, the detecting portion 22 cannot enter the deflection spaces 13 and the front retainer 20 cannot reach the proper mount position. As just described, whether or not all the terminal fittings 16 are properly inserted and whether or not there is any terminal fitting 16 in the incompletely inserted state can be detected based on whether or not the front retainer 20 can be properly mounted.

The front retainer 20 of this embodiment is molded into a predetermined shape by a mold 30 (see FIG. 6). After molding, ejector pins 31 provided in the mold 30 press the rear end parts 22R of the detecting portions 22 forwardly, whereby the front retainer 20 is released from the mold 30. A pressing direction by the ejector pins 31 is a direction parallel to the mounting direction of the front retainer 20 to the housing 10 and both upper and lower plate surfaces of the detecting portions 22.

The front end surface of the ejector pin 31 is shaped to conform to the rear end surface of the detecting portion 22 since having both a function of pressing the detecting portion 22 to release the front retainer 20 and a function as a molding surface for molding the rear end surface of the detecting portion 22. Specifically, as shown in FIG. 6, the front end surface of the ejector pin 31 is formed with a first pressing surface 33, an inclined pressing surface 34, a contact surface 38, a second pressing surface 36 and an arcuate concave surface 37 which correspond to and come into surface contact with the first pressure receiving surface 23, the detecting surface 24, the restricting surface 28, the second pressure receiving surface 26 and the arcuate convex surface 27 of the detecting portion 22.

When the ejector pin 31 presses the detecting portion 22, the first pressing surface 33, the inclined pressing surface 34, the second pressing surface 36 and the arcuate concave surface 37 press in a surface-contact state. Here, any of the detecting surface 24, the inclined pressing surface 34, the arcuate convex surface 27 and the arcuate concave surface 37 is facing obliquely to the pressing direction of the ejector pin 31. Thus, the detecting portion 22 may receive an oblique upward force by a pressing force from the ejector pin 31 and be improperly deformed outside the mold 30.

However, since any of the first pressure receiving surface 23, the first pressing surface 33, the second pressure receiving surface 26 and the second pressing surface 36 is a flat surface at a right angle to the pressing direction of the ejector pin 31, the detecting portion 22 and the ejector pin 31 are not relatively displaced in the front-back direction. Thus, even if the detecting portion 22 is pressed obliquely upwardly by the inclined pressing surface 34 and the arcuate concave surface 37, the detecting portion 22 is relatively displaced neither upwardly nor downwardly with respect to the ejector pin 31.

As described above, the connector A of this embodiment includes the housing 10 formed with the plurality of terminal accommodating chambers 11 inside and the front retainer 20 to be mounted to the housing 10 from the front side of the housing 10. The locking lances 12 cantilevered forward and configured to retain the terminal fittings 16 by locking the terminal fittings 16 properly inserted into the terminal accommodating chambers 11 are formed in the housing 10. Likewise, the deflection spaces 13 configured to allow the locking lances 12 to be resiliently displaced due to interference with the terminal fittings 16 in the incompletely inserted state are formed in the housing 10.

The front retainer 20 is formed with the detecting portions 22 configured to restrict the separation of the locking lances 12 from the terminal fittings 16 by entering the deflection spaces 13 with the terminal fittings 16 properly inserted. The rear end part 22R of the detecting portion 22 is formed with the detecting surface 24 inclined with respect to the virtual orthogonal plane S orthogonal to the mounting direction of the front retainer 20 and configured to butt against the locking lance 12 located in the deflection space 13 when the terminal fitting 16 is in the incompletely inserted state. Likewise, the rear end part 22R of the detecting portion 22 is formed with the first and second pressure receiving surfaces 23, 26 set to be at smaller angles to the virtual orthogonal plane S than the detecting surface 24.

In releasing the front retainer 20 from the mold 30 in the process of forming the front retainer 20 using the mold 30, the ejector pins 31 press the first and second pressure receiving surfaces 23, 26. The first and second pressure receiving surfaces 23, 26 are at 0° to the virtual orthogonal plane S orthogonal to the mounting direction of the front retainer 20 and this angle of 0° is smaller than the angle α of the detecting surface 24 to the virtual orthogonal plane S. Thus, the detecting portion 22 is not improperly deformed even if being pressed by the ejector pin 31.

Further, the first and second pressure receiving surfaces 23, 26 are arranged at two positions across the detecting surface 24 in the resilient displacement direction (vertical direction) of the locking lances 12. According to this configuration, since the pressing positions of the detecting portion 22 by the ejector pin 31 are dispersed at two upper and lower positions, improper deformation of the detecting portion 22 in the vertical direction can be reliably prevented.

Further, the rear end part 22R of the detecting portion 22 is formed with the stepped restricting portion 25 arranged between the second pressure receiving surface 26 and the detecting surface 24 and located at such a position that the second pressure receiving surface 26 is retracted from the detecting surface 24. The upward facing contact surface 38 of the ejector pin 31 is in contact with the downward facing restricting surface 28 of the detecting portion 22. According to this configuration, the ejector pin 31 pressing the second pressure receiving surface 26 can be prevented from being displaced toward the detecting surface 24 (upwardly) with respect to the detecting portion 22.

Further, the plurality of locking lances 12 are juxtaposed in the lateral direction in the housing 10. The detecting portion 22 is in the form of such a plate as to correspond to these plurality of locking lances 12. According to this configuration, since the detecting portion 22 is high in rigidity, the improper deformation of the detecting portion 22 can be more reliably prevented.

The present invention is not limited to the above described and illustrated embodiment. For example, the following embodiments are also included in the technical scope of the present invention.

Although the two pressure receiving surfaces are parallel to the virtual orthogonal plane in the above embodiment, at least one of the pressure receiving surfaces may be inclined with respect to the virtual orthogonal plane.

Although the two pressure receiving surfaces are at the same angle to the virtual orthogonal plane in the above embodiment, the angels of the two pressure receiving surfaces to the virtual orthogonal plane may be different.

Although two pressure receiving surfaces are provided in the above embodiment, the number of the pressure receiving surfaces may be only one, three or more.

Although one plate-like detecting portion corresponds to the plurality of locking lances in the above embodiment, a plurality of detecting portions may be provided and one detecting portion may correspond to one locking lance.

### LIST OF REFERENCE SIGNS

A . . . connector
S . . . virtual orthogonal plane
α . . . angle of detecting surface to virtual orthogonal plane
10 . . . housing
11 . . . terminal accommodating chamber
12 . . . locking lance
13 . . . deflection space
16 . . . terminal fitting
20 . . . front retainer
22 . . . detecting portion
22R . . . rear end part of the detecting portion
23 . . . first pressure receiving surface (pressure receiving surface)
24 . . . detecting surface
25 . . . restricting portion
26 . . . second pressure receiving surface (pressure receiving surface)

What is claimed is:

1. A connector (A), comprising:
a housing (10) formed with a terminal accommodating chamber (11);
a locking lance (12) cantilevered forward and configured to retain a terminal fitting (16) by locking the terminal fitting (16) properly inserted into the terminal accommodating chamber (11);
a deflection space (13) configured to allow the locking lance (13) to be displaced resiliently due to interference with the terminal fitting (16) in an incompletely inserted state;
a front retainer (20) to be mounted to the housing (10) from front;
a detecting portion (22) formed on the front retainer (20) and configured to restrict the separation of the locking lance (12) from the terminal fitting by entering the deflection space (13) with the terminal fitting (16) properly inserted;
a detecting surface (24) formed on a rear end part of the detecting portion (22), inclined with respect to a virtual orthogonal plane (S) orthogonal to a mounting direction of the front retainer (20) and configured to butt against the locking lance (12) located in the deflection space (13) when the terminal fitting (16) is in the incompletely inserted state; and
a pressure receiving surface (23, 26) formed on the rear end part of the detecting portion (22) and set to be at a smaller angle to the virtual orthogonal plane (S) than an angle of the detecting surface (24) to the virtual orthogonal plane (S).

2. The connector of claim 1, wherein two pressure receiving surfaces (23, 26) are arranged at two positions across the detecting surface (24) in a resilient displacement direction of the locking lance (12).

3. The connector of claim 2, wherein a restricting portion (25) is formed on the rear end part of the detecting portion (22), the restricting portion (25) being arranged between the pressure receiving surfaces (23, 26) and the detecting surface (24) and being stepped such that the pressure receiving surface (23, 26) is retracted from the detecting surface (24).

4. The connector of claim 3, wherein:
a plurality of the locking lances (12) are juxtaposed; and
the detecting portion (22) is in the form of a plate to correspond to the plurality of locking lances (12).

3. The connector of claim 1, wherein a restricting portion (25) is formed on the rear end part of the detecting portion (22), the restricting portion (25) being arranged between the pressure receiving surface (23, 26) and the detecting surface (24) and being stepped such that the pressure receiving surface (23, 26) is retracted from the detecting surface (24).
